(19) United States
(12) Patent Application Publication
(10) Pub. No.: US 2007/0018939 A1
(43) Pub. Date: Jan. 25, 2007

(54) Source driver circuit and driving method for liquid crystal display device

(75) Inventors: Lin-Chien Chen, Hsin Chu City (TW); Dar-Chang Juang, Hsin Chu City (TW)

Correspondence Address: BIRCH STEWART KOLASCH & BIRCH, PO BOX 747, FALLS CHURCH, VA, 22040-0747, US

(73) Assignee: Sunplus Technology Co., Ltd.

(21) Appl. No.: 11/244,103

(22) Filed: Oct. 6, 2005

(30) Foreign Application Priority Data
Jul. 22, 2005 (TW) 094124799

(51) Int. Cl. G09G 3/36

(52) U.S. Cl. 345/100

(57) ABSTRACT

The invention relates to a source driver circuit and method for a LCD device. The source driver circuit includes a plurality of source drivers. Each source driver includes two data buffers, two digital-to-analog converters, two amplifiers, a switch module and two black insertion units. The invention uses the black insertion units to directly provide black insertion voltages required in a black insertion step without use of digital-to-analog converters and amplifiers, thereby achieving higher the driving speed of the source driver circuit and lower power consumption of the amplifiers.

This application claims the benefit of the filing date of Taiwan Application Ser. No. 094124799, filed on Jul. 22, 2005, the content of which is incorporated herein by reference.

### BACKGROUND OF THE INVENTION

1. Field of the invention

The invention generally relates to a liquid crystal display (LCD), and more particularly, to a source driver circuit and method for a liquid crystal display device.

2. Description of the Related Art

FIG. 1A shows a schematic configuration of a prior LCD device. Referring to FIG. 1A, a LCD device 100 includes a LCD panel 110, a source driver circuit 120, a gate driver circuit 130, a timing controller 140 and a gamma adjustment circuit 150. The LCD panel 110 is used to display images. A plurality of data lines 121 and a plurality of scanning lines 131 (e.g. 640×480) are disposed in a grid like arrangement on the LCD panel 110. A TFT (thin film transistor) 111 and a capacitor 112 are provided in the vicinity of each point of intersection between the data lines 121 and scanning lines 131. The capacitor 112 includes a pixel electrode 112a, a common electrode 112b and a liquid crystal layer 112c. A gate electrode of TFT 111 is connected to the scanning line 131, a source electrode is connected to the data line 121, and a drain electrode is connected to the pixel electrode 112a of the capacitor 112. The gamma adjustment 150 applies at least a reference voltage to the source driver circuit 120. Besides, the timing controller 140 generates different control signals and control voltages to the source driver circuit 120 and the gate driver circuit 130.

If the liquid crystal material is continuously applied with a DC voltage with same polarity, the liquid crystal material will likely be damaged. To prevent the damage to the liquid crystal material, the polarity of the data signal applied to the liquid crystal material is periodically inverted (so-called AC driving), as well know in the art.

FIG. 1B shows a schematic configuration of a prior source driver circuit. The source driver circuit 120 consists of a plurality of source driver 160. Each source driver 160 includes two data buffers 161, 161′, a positive digital-to-analog converter 162, a negative digital-to-analog converter 163, a positive amplifier 164, a negative amplifier 165 and a switch module 166 made up of four switches SW1˜SW4. Based on the AC driving, the source driver 160 respectively receives two digital image signals D₁, D₂, and simultaneously receives a set of positive analog voltage signals V_{ref1} and a set of negative analog voltage signals V_{ref2} from the gamma adjustment 150. After two digital image signals D₁, D₂ are converted and amplified, a positive analog image signal and a negative analog image signal are alternately output from the output terminals S1, S2 of the driver 160 for every predetermined period of time by controlling four switches SW1˜SW4. Four switches SW1˜SW4 are controlled by a control signal CS_SW, which includes a first switch control signal, a second switch control signal, a third switch control signal and a fourth switch control signal for respectively controlling switches SW1˜SW4. Since the method of using the control signal CS_SW to control the switches SW1˜SW4 is well known, the description is omitted here.

If motion picture display is conducted on the prior LCD device, an afterimage problem will arise. The cause of this problem is that because the response speed of the liquid crystal material is low and the response time is relatively long. When an object is moving fast in a frame, the liquid crystal is unable to track the path of the object within a frame period, but produces a cumulative response using several frame periods. Several researches have been conducted to overcome the afterimage problem as follows: (1) Intrinsic property: Convert the property of the liquid crystal material into low viscosity. (2) Overdriving: The response of the liquid crystal material can be increased by overdriving each pixel. (3) Black insertion: Following the display of each image for one frame, the entire screen is switched to a black display by inserting the black data, before the image for the next frame is displayed.

FIG. 2A shows a timing diagram for sequentially supplying of the gate driving signals to the scanning lines of a conventional LCD device. In U.S. Pat. No. 6,473,077, IBM discloses a liquid crystal display device using black insertion concept. FIG. 2B shows a timing diagram of sequential gate driving signals output from a gate driver circuit 130 of the liquid crystal display device to the scanning lines. Based on the same black insertion concept, in U.S. Pat. No. 6,819,311, NEC reveals another liquid crystal display device for displaying motion pictures. FIG. 2C shows a timing diagram of sequential gate driving signals output from a gate driver circuit 130 of another liquid crystal display device for displaying motion pictures to the scanning lines.

Referring to FIG. 2A, there is a gate driving signal with a time period T_{G} supplied to each scanning line within a frame period while the gate driving signal supplied to each scanning line comprises a first trigger pulse P₁ and a second trigger pulse P₂ within a frame period as shown in FIG. 2B and 2C.

As shown in FIG. 2B, one frame period is divided into two halves. An image for one frame is displayed during the first half of frame period, and the black image is displayed during the second half of frame period. Referring to FIG. 2C, the gate driver circuit 130 interlacedly activates a pixel line for image data and then another pixel line for black data which is separated by a predetermined number of scanning lines from the pixel line for image data. In this manner, the interlaced activated pixel lines are sequentially displayed on the LCD device. Comparing FIG. 2A˜2C, the scanning frequency of the gate driver circuit 130 in FIG. 2B or FIG. 2C is doubled, since the width TG of the gate driving signal on each scanning line in FIG. 2A is reduced into the width T_{G}/2 of the trigger pulse P₁ or P2 as shown in FIG. 2B or FIG. 2C. That is, the operation time of the gate driver circuit 130 is reduced to one-half, and the data driving speed of the source driver circuit 120 is also doubled in order to coordinate with the scanning frequency of the gate driver circuit 130.

Although the afterimage problem can be solved with NEC's or IBM's architecture, the gate driver circuit has to alternately generate image data and black insertion data for implementing the black insertion technique. Since image data and black insertion data are generated by the digital-to-analog converters and the amplifiers within different time periods, the scanning frequency of the gate driver circuit must be doubled, thereby relatively increasing the load of the source driver circuit and the response speed of the digital-to-analog converter in the source driver circuit.

### SUMMARY OF THE INVENTION

In view of the above-mentioned problems, an object of the invention is to provide a source driver circuit for a LCD device, the black insertion voltages for black pixels of which are directly generated by a gamma adjustment circuit of the LCD device.

Another object of the invention is to provide a source driver circuit for a LCD device, the black insertion voltages for black pixels of which are directly generated by the gamma adjustment circuit of the LCD device and the scanning frequency of the gate driver circuit need not be doubled.

To achieve the above-mentioned object, the source driver circuit for a LCD device comprises a plurality of source drivers. After having received two digital image signals, each source driver outputs a first driving signal and a second driving signal. Each gate driving signal has a first trigger pulse and a second trigger pulse within a frame period. Each source driver comprises two data buffer, two digital-to-analog converters, two amplifiers, a switch module, a first black insertion unit and a second black insertion unit.

Each data buffer receives a digital image signal. Each digital-to-analog converter is connected to the data buffer and converts the data output from the data buffers into an analog image signal according to a set of reference analog voltage signals. Two amplifiers respectively receive and amplify the two analog image signals from the two digital-to-analog converters, and then output a first amplified signal and a second amplified signal. After having received the first and the second amplified signals, the switch module outputs two amplified signals as the first and the second driving signals within the first trigger pulse period. The first and the second black insertion units simultaneously receive the first and the second black insertion voltages, and each selectively outputs one of two black insertion voltages as the first driving signal and the second driving signal, respectively, within the second trigger pulse period.

Still another object of the invention is to provide a source driving method for a LCD device in which a plurality of scanning lines and a plurality of signal lines are disposed in a grid arrangement. Each gate driving signal supplied to each scanning line has a first trigger pulse and a second trigger pulse within a frame period. The source driving method comprises amplifying and outputting a plurality of analog image signals to the plurality of signal lines after converting a plurality of digital image signals into the plurality of analog image signals within the first trigger pulse period, and directly outputting two black insertion voltages to the plurality of signal lines within the second trigger pulse period.

Based on the black insertion technique, a unique feature of the present invention is that the relative voltages for full black pixels are supplied by the gamma adjustment circuit without use of the amplifier. The invention not only accelerates the driving speed of the source circuit, but also lowers the power consumption of the amplifier. The invention can make flexible use of the first trigger pulse period since the second trigger pulse period is reduced.

### BRIEF DESCRIPTION OF THE DRAWINGS

FIG. 1A shows a schematic configuration of a prior LCD device.

FIG. 1B shows a schematic configuration of a prior source driver circuit.

FIG. 2A shows a timing diagram for sequentially supplying of the gate driving signals to the scanning lines of a conventional LCD device.

FIG. 2B shows a timing diagram for sequentially supplying of the gate driving signals to the scanning lines of another conventional LCD device.

FIG. 2C shows a timing diagram for sequentially supplying of the gate driving signals to the scanning lines of also another conventional LCD device.

FIG. 3 shows a schematic configuration of a source driver circuit according to the invention.

FIG. 4A shows a schematic configuration of a source driver circuit according to a first embodiment of the invention.

FIG. 4B shows a timing diagram for sequentially supplying of the gate driving signals to the scanning lines according to the first embodiment of the invention.

FIG. 4C shows another timing diagram for sequentially supplying of the gate driving signals to the scanning lines according to the first embodiment of the invention.

FIG. 5 shows another schematic diagram of the black insertion unit.

FIG. 6 is a flow chart illustrating the source driving method according to the invention.

FIG. 7 shows a schematic configuration of a source driver circuit according to a second embodiment of the invention.

FIG. 8 shows a schematic configuration of a source driver circuit according to a third embodiment of the invention.

FIG. 9 shows a schematic configuration of a source driver circuit according to a fourth embodiment of the invention.

### DETAILED DESCRIPTION OF THE INVENTION

The source driver circuit and method for a liquid crystal display device of the invention will be described with reference to the accompanying drawings.

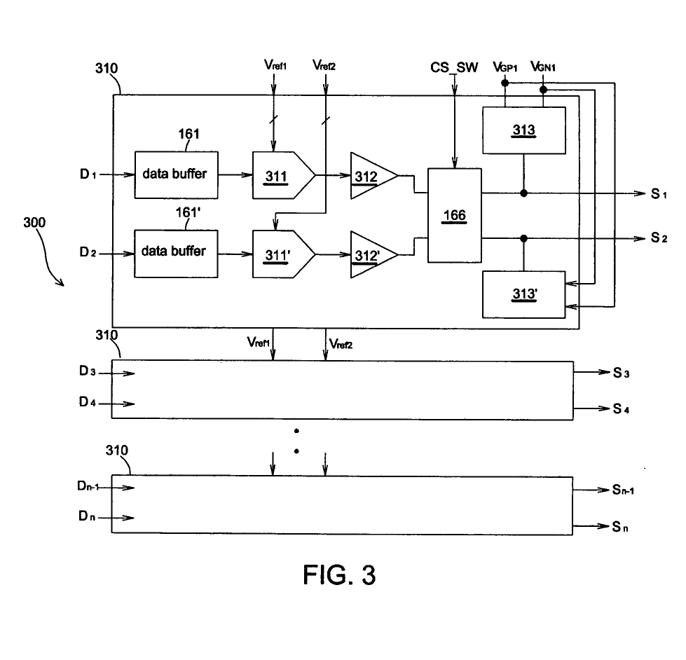

FIG. 3 shows a schematic configuration of a source driver circuit according to the invention. The source driver circuit 300 for a liquid crystal display device includes a plurality of source drivers 310. Each source driver 310 comprises two data buffer 161, 161′, two digital-to-analog converters 311, 311′, two amplifiers 312, 312′, a switch module 166, a first black insertion unit 313 and a second black insertion unit 313′.

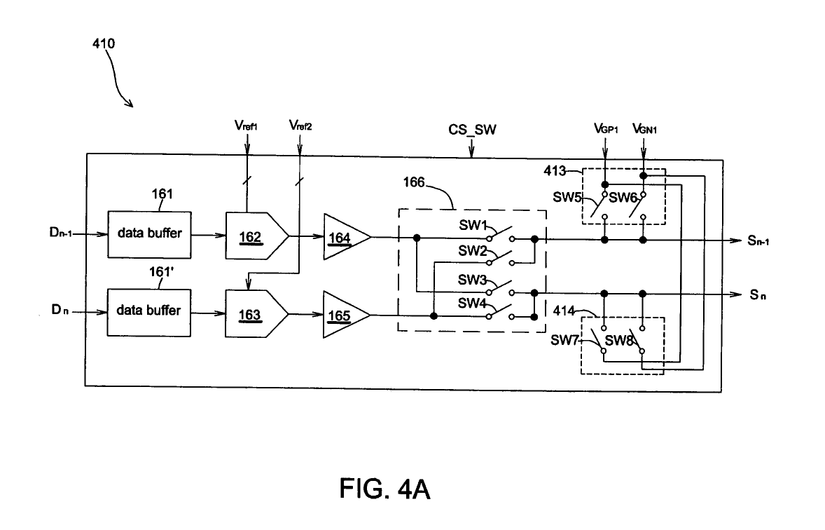

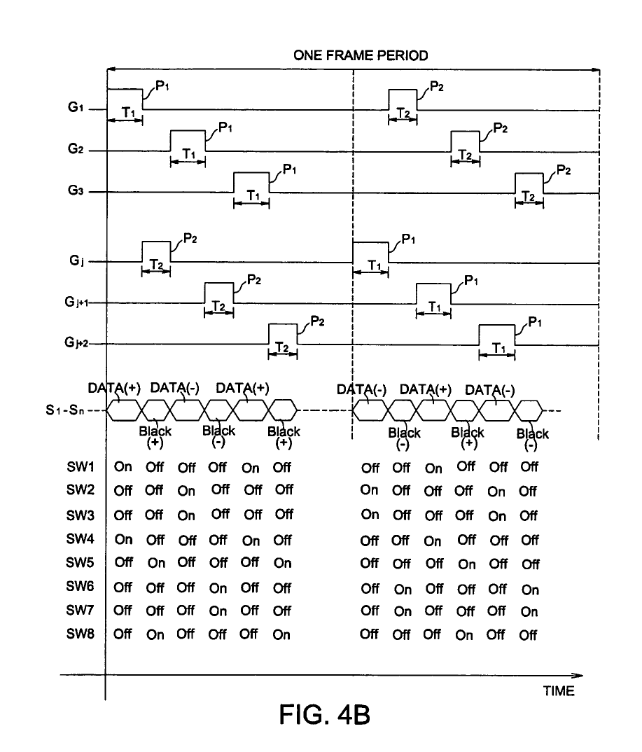

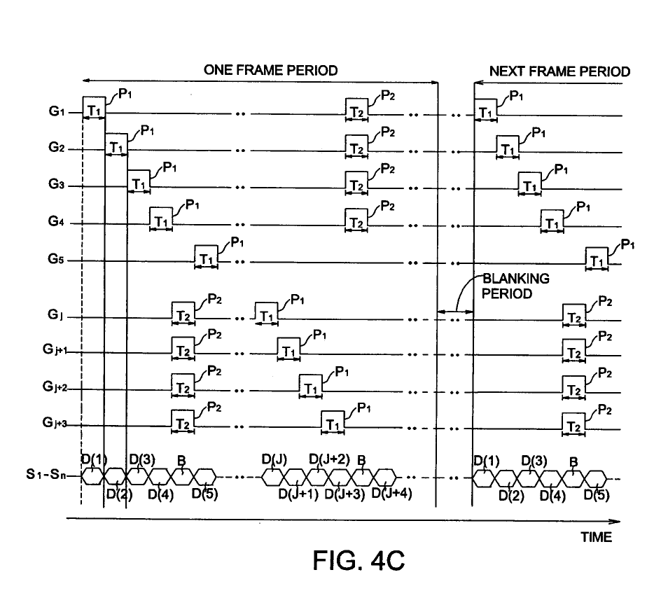

Data buffers 161, 161′ in each source driver 310 respectively receive digital image signals Dₙ₋₁, Dₙ, where n is an integer greater than 1. Each digital-to-analog converter 311(311′) receives a set of reference analog voltage signals (V_{ref1} or V_{ref2}) and a digital image signal Dₙ₋₁(Dₙ), and then selects a corresponding reference analog voltage signal among the set of reference analog voltage signals (V_{ref1} or V_{ref2}) according to the received digital image signal Dₙ₋₁(Dₙ). Two amplifiers 312, 312′ respectively receive and amplify the output signals from two digital-to-analog converters 311, 311′, and then sequentially output a first amplified signal and a second amplified signal. The switch module 166 is located between two amplifiers 312, 312′ and two output terminals Sₙ, Sₙ₋₁ of the source driver 310. The first and the second amplified signals output from two amplifiers 312, 312′ are under the control of the switch module and output to two output terminals Sₙ, Sₙ₋₁ as the first and the second driving signals in a normal mode. The normal mode and the black insertion mode will be described in FIG. 4B, 4C. The first black insertion unit 313 receives the first and the second black insertion voltages, and then output the first black insertion voltage or the second black insertion voltage as the first driving signal in the black insertion mode. Likewise, the second black insertion unit 313′ receives the first and the second black insertion voltages, and then outputs the first black insertion voltage or the second black insertion voltage as the second driving signal in the black insertion mode.

FIG. 4A shows a schematic configuration of a source driver circuit according to a first embodiment of the invention. FIG. 4B shows a timing diagram for sequentially supplying of the gate driving signals to the scanning lines according to the first embodiment of the invention. FIG. 4C shows another timing diagram for sequentially supplying of the gate driving signals to the scanning lines according to the first embodiment of the invention.

Hereinafter, timing diagrams in FIG. 4B and 4C are used as examples to detail the operation and the architecture of the invention. Besides, since the source driver circuit consists of a plurality of equal source drivers, only one source driver will be described below.

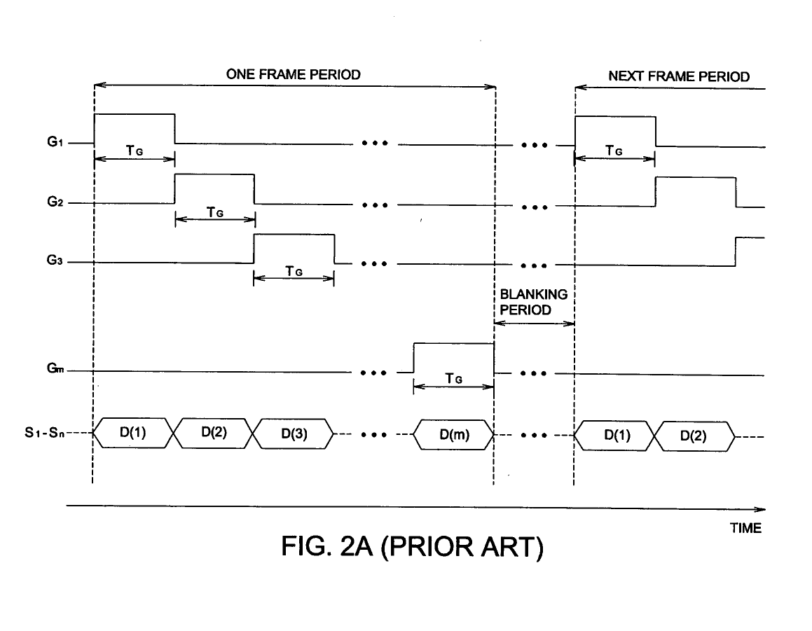

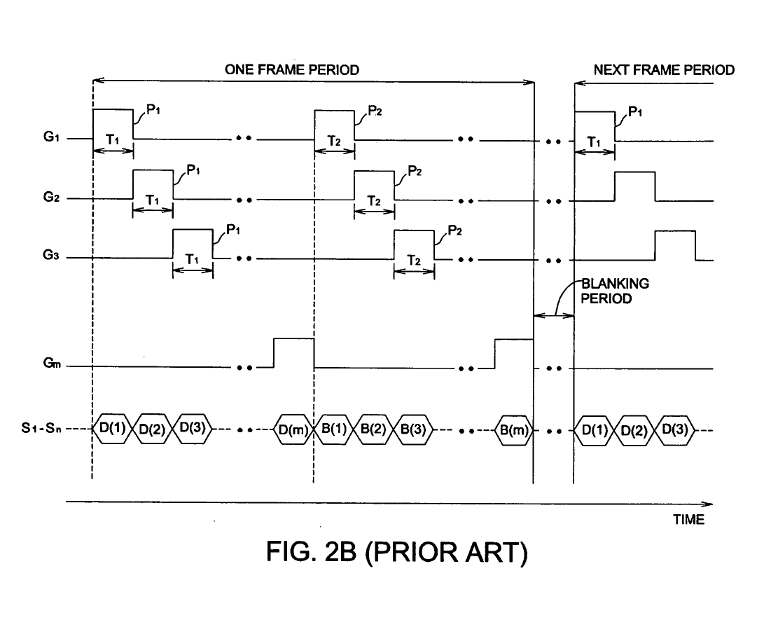

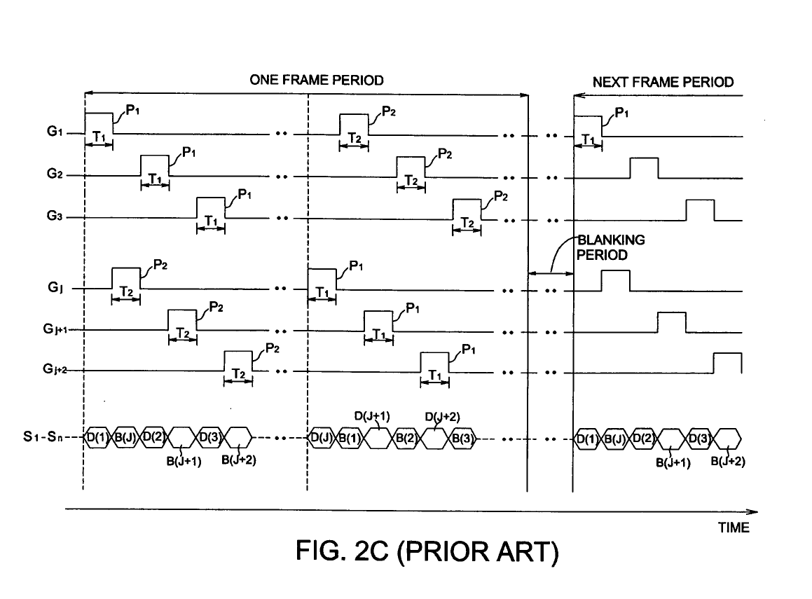

According to the invention, referring to FIG. 2A, 4B, a time period T_{G} supplied to the scanning lines by the gate source circuit 130 is divided into a first trigger pulse P₁ with a time period T₁ and a second trigger pulse P₂ with a time period T₂ within a frame period. Therefore, the data outputting status is classified into two modes, which includes a normal mode for the first trigger pulse period T₁ and a black insertion mode for the second trigger pulse period T₂.

As shown in FIG. 4A, according to the first embodiment of the invention, each source driver 410 includes two data buffers 161, 161′, a positive digital-to-analog converter 162, a negative digital-to-analog converter 163, a positive amplifier 164, a negative amplifier 165, a switch module 166 made up of four switches SW1˜SW4, a first black insertion unit 413 and a second black insertion unit 414. According to a received a digital image signal Dₙ₋₁, a corresponding analog voltage signal is selected and output as a positive analog image signal among the set of positive analog voltage signals V_{ref1} by the positive digital-to-analog converter 162. The positive amplifier 164 receives and amplifies the positive analog image signal, and then outputs as a first amplified signal. According to a received a digital image signal Dₙ, a corresponding analog voltage signal is selected and output as a negative analog image signal among the set of negative analog voltage signals V_{ref2} by the negative digital-to-analog converter 163. The negative amplifier 165 receives and amplifies the negative analog image signal, and then outputs as a second amplified signal.

Four switches SW1˜SW4 make up the switch module 166 and are respectively controlled by a switch control signal CS_SW. The two terminals of the first switch SW1 are respectively connected to the positive amplifier 164 and the output terminals Sₙ₋₁ of the source driver 410. The first switch SW1 receives the first amplified signal and is under the control of a first switch control signal. The two terminals of the second switch SW2 are respectively connected to the negative amplifier 165 and the output terminals Sₙ₋₁ of the source driver 410. The second switch SW2 receives the second amplified signal and is under the control of a second switch control signal. The two terminals of the third switch SW3 are respectively connected to the positive amplifier 164 and the output terminals Sₙ of the source driver 410. The third switch SW3 receives the first amplified signal and is under the control of a third switch control signal. The two terminals of the fourth switch SW4 are respectively connected to the negative amplifier 165 and the output terminals Sₙ of the source driver 410. The fourth switch SW4 receives the second signal and is under the control of a fourth control signal.

Black insertion units 413, 414 simultaneously receive a first black insertion voltage V_{GP1} and a second black insertion voltage V_{GN1}. The black insertion unit 413 includes two switches SW5, SW6 which respectively receive the first black insertion voltage V_{GP1} and the second black insertion voltage V_{GN1}, and are respectively under the control of the fifth control signal and the sixth control signal. Only one of switches SW5, SW6 is turned ON in the black insertion mode so that one of the first black insertion voltage V_{GP1} and the second black insertion voltage V_{GN1} is output to the output terminals Sₙ₋₁ of the source driver 410 as the first driving signal. The black insertion units 414 includes two switches SW7, SW8 which respectively receive the first black insertion voltage V_{GP1} and the second black insertion voltage V_{GN1}, and are respectively under the control of the seventh control signal and the eighth control signal. Only one of switches SW7, SW8 is turned ON in the black insertion mode so that one of the first black insertion voltage V_{GP1} and the second black insertion voltage V_{GN1} is output to the output terminals Sₙ of the source driver 410 as the second driving signal.

To prevent the damage to the liquid crystal material, the polarity of the data signal applied to the liquid crystal material is periodically inverted. Therefore, the source driver 410 alternately inverts the data output to the data lines 121 for every predetermined period of time. Accordingly, each of the switches SW1˜SW4 is selectively turned ON or OFF. As shown in FIG. 4B, if the polarity of the image signal is positive within the first trigger pulse period T₁ (in the normal mode), switches SW1, SW4 are turned ON (i.e. short) and the other switches are turned OFF (i.e. open), so that the positive and the negative analog signals are respectively output from the output terminals Sₙ₋₁, Sₙ of the source driver 410. Contrarily, if the polarity of the image signal is negative, switches SW2, SW3 are turned ON and the other switches are turned OFF, so that the positive and the negative analog signals are respectively output from the output terminals Sₙ, Sₙ₋ₗ of the source driver 410.

If the polarity of the black insertion voltage is positive within the second trigger pulse period T₂ (in the black insertion mode), switches SW5, SW8 are turned ON and the other switches are turned OFF, so that the first black insertion voltage V_{GP1} and the second black insertion voltage V_{GN1} are respectively output from the output terminals Sₙ, Sₙ₋₁ of the source driver 410. Contrarily, if the polarity of the black insertion voltage is negative, switches SW6, SW7 are turned ON and the other switches are turned OFF, so that the first black insertion voltage V_{GP1} and the second black insertion voltage V_{GN1} are respectively output from the output terminals Sₙ₋₁, Sₙ of the source driver 410.

Both the positive analog voltage V_{ref1} and the negative analog voltage V_{ref2} are a set of bus signals, which together with the first black insertion voltage V_{GP1} and the second black insertion voltage V_{GN1} are supplied by the gamma adjustment circuit 150. The amplitude of the voltages can be directly set or adjusted from a control chip to apply to different LCD panels. It should be noted that a black display followed an image is used to emphasized the contrast; other colors may also be used with different effects. If a color other than black is used for contrast, a corresponding adjustment must be made to the amplitudes of the first black insertion voltage V_{GP1} and the second black insertion voltage V_{GN1}.

According to the invention, the relative voltages for the full black pixels are directly provided by the gamma adjustment circuit rather than by the amplifier any more. Therefore, the second trigger pulse period T₂ is reduced so that the first trigger pulse period T₁ can be flexibly used, thereby varying the timing design of driver circuit. For example, in the timing diagram of FIG. 4C, there are four scanning lines, whose activated times of the second trigger pulse period T₂ are the same within a frame period. The scanning method used in FIG. 4C is that a black insertion mode is inserted for every four normal modes by the gate driver circuit 130; meanwhile, there are four scanning lines (G₁˜G₄ or Gⱼ˜Gⱼ₊₃) to which the second trigger pulse are supplied within the second trigger pulse period T₂. Hence, the first trigger pulse period T₁ of the invention is greater than the period T_{G}/2 of each pulse on each scanning line in FIG. 2B, 2C. In comparison with the prior art, the time for writing the image signals into the capacitances 112 is longer, and the image quality of the LCD panel is better.

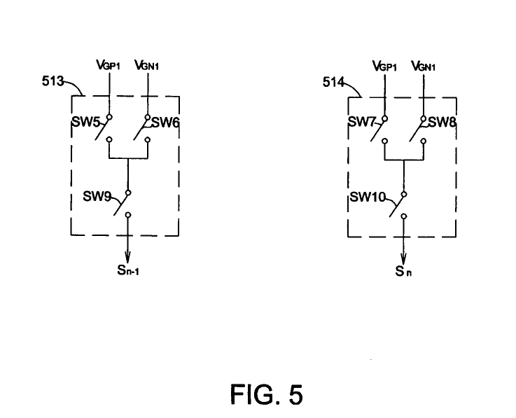

FIG. 5 shows another schematic diagram of the black insertion unit. Referring to FIG. 5, black insertion units 513,514 simultaneously receive a first black insertion voltage V_{GP1} and a second black insertion voltage V_{GN1}. The black insertion unit 513 includes three switches SW5, SW6, SW9, which are electrically connected to the output terminals Sₙ₋₁, Sₙ of the source driver. The switches SW5, SW6, SW9 are respectively under the control of the fifth control signal, the sixth control signal and the ninth control signal. Both of switches SW5, SW6 cannot be turned ON at the same time. The black insertion unit 514 includes three switches SW7, SW8, SW10, which are respectively under the control of the seventh control signal, the eighth control signal and the tenth control signal. Both of switches SW7, SW8 cannot be turned ON at the same time. Wherein, the abovementioned fifth control signal, the sixth control signal, the seventh control signal, the eighth control signal, the ninth control signal and the tenth control signal are controlled by the switch control signal CS_SW. The switches SW5˜SW10 can be implemented using PMOS transistors or NMOS transistors or transmission gates.

In the prior art, image signals or black insertion voltages are passed through amplifiers 164, 165, which causes a severe power consumption problem. With regard to the demand for doubling the data driving speed of the source driver circuit 120 to coordinate with the speed of the gate driver circuit 130, the increased data driving speed of the source driver circuit 120 is, however, limited by the time delay resulted from the operations of the amplifiers 164, 165. In comparison with the prior art, the black insertion voltages V_{GP1}, V_{GN1} passed through the switches SW5, SW6, without going through the amplifiers 164, 165, can be output faster from the output terminals Sₙ₋₁, Sₙ of the source driver according to the invention. Therefore, the second trigger pulse period T₂ can be less than the first trigger pulse period T₁. During the second trigger pulse period T₂, the amplifiers 164, 165 can be shut down or prepared for next image signals. Hence, the invention not only lowers the power consumption of the amplifiers 164, 165, but also accelerates the data driving speed of the source driver circuit 120. Accordingly, the second trigger pulse period T₂ is reduced so that first trigger pulse period T₁ can be prolonged sufficiently for writing the image signals to capacitances 112, thereby enhancing the image quality of the LCD panel.

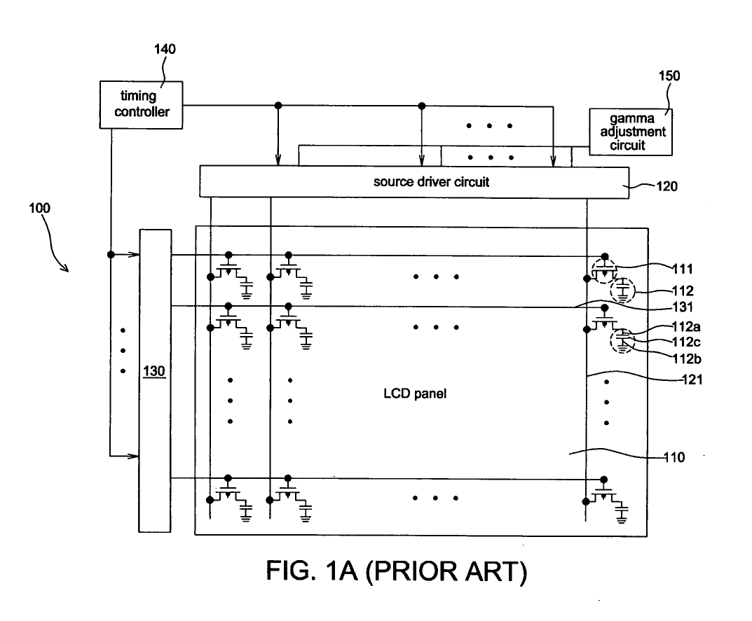

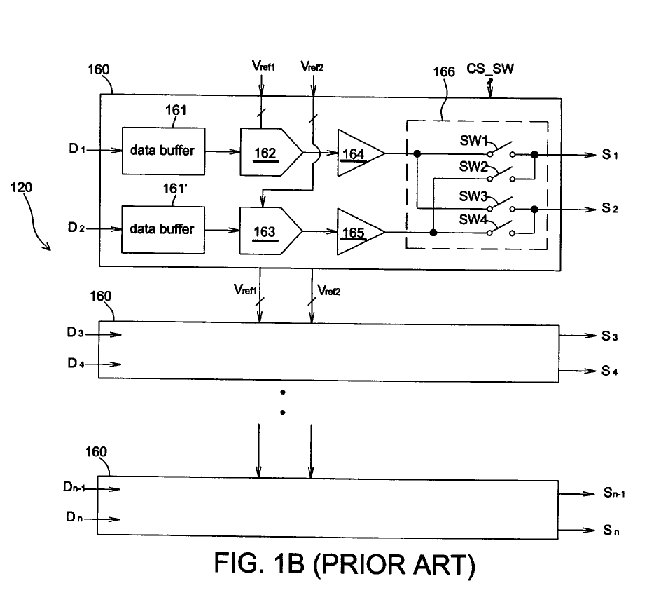

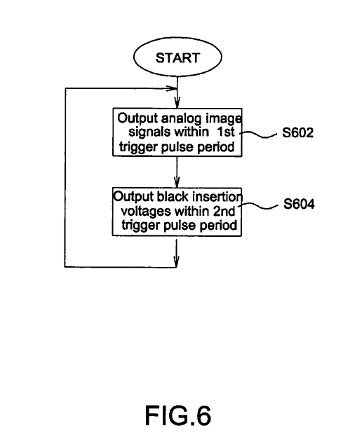

FIG. 6 is a flow chart illustrating the source driving method according to the invention. The source driving method of the invention will be hereinafter described with referring to FIG. 1, 4B, 4C and 6.

The source driving method of the invention is applied to a LCD panel 110. A plurality of scanning lines and a plurality of signal lines are disposed in a grid arrangement on the LCD panel 110. As mentioned above, each gate driving signal supplied to each scanning line has a first trigger pulse P₁ and a second trigger pulse P₂ within a frame period. The source driving method comprises the following steps. In step S602, after a plurality of digital image signals have been converted into the plurality of analog image signals, the plurality of analog image signals are amplified and then output to the plurality of signal lines 121 within the first trigger pulse period T₁. In step S604, two different black insertion voltages are output to the corresponding signal lines 121 within the second trigger pulse period T₂ according to the polarities. Then, the flow returns to step 602 to process the following digital image signals.

Wherein, the second trigger pulse of each gate driving signal is not synchronized (shown in FIG. 4B), or the second trigger pulses of N gate driving signals may be synchronized (shown in FIG. 4C). One of two sets of reference analog voltage signals is a set of positive analog voltage signals V_{ref1}, and the other is a set of negative analog voltage signals V_{ref2}. Likewise, one of two black insertion voltages is a positive voltage V_{GP1}, and the other is a negative voltage V_{GN1}. Two sets of analog voltage signals and two black insertion voltages are all supplied by the gamma adjustment circuit 150.

In step S602, according to a set of positive analog voltage signals V_{ref1}, a plurality of digital image signals Dₙ₋₁ are converted into a plurality of positive analog image signals and then are amplified. Meanwhile, according to a set of negative analog voltage signals V_{ref2}, a plurality of digital image signals Dₙ are converted into a plurality of negative analog image signals and then are amplified. Afterwards, two amplified analog image signals are output to the corresponding signal lines according to the predetermined polarity of each liquid crystal layer within the first trigger pulse period T1. In step S604, two black insertion voltages are output to the corresponding signal lines according to the predetermined polarity of each liquid crystal layer within the second trigger pulse period T₂. The abovementioned operations are based on the periodic inversion of the polarities of the black insertion voltages and the analog image signals output to the signal lines for every predetermined period of time.

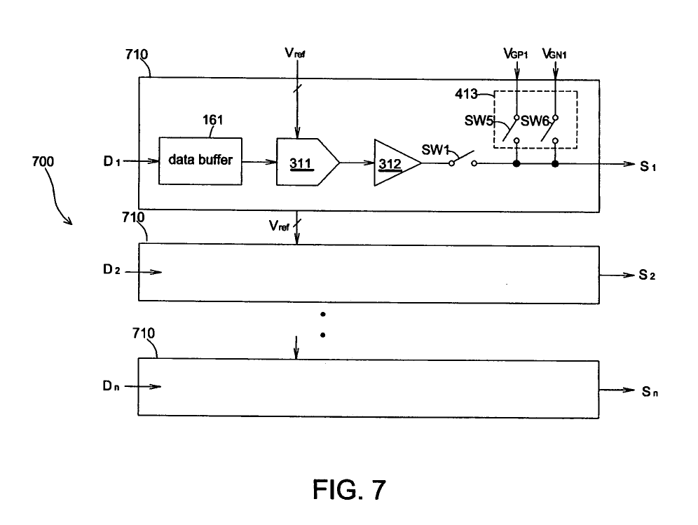

FIG. 7 shows a schematic configuration of a source driver circuit according to a second embodiment of the invention.

Referring to FIG. 7, the source driver circuit 700 includes a plurality of source drivers 710 according to a second embodiment of the invention. Each source driver 710 receives a digital image signal and then outputs a driving signal. Each gate driving signal supplied to the scanning lines is divided into a first trigger pulse P₁ and a second trigger pulse P₂ within a frame period. Each source driver 710 includes a data buffer 161, a digital-to-analog converter 162, an amplifier 164, a switch SW1 and a black insertion unit 413.

The switch SW1 receives the amplified signal output from the amplifier 164, and then is turned ON (i.e. short) to output the amplified signal as the driving signal within the first trigger pulse period T₁. During the second trigger pulse period T₂, the switch SW1 is turned OFF (i.e. open) and the black insertion unit 413 outputs a black insertion voltage as the driving signal. The operations of all devices included in the source driver 710 are described above so the description is omitted.

Since the source driver circuits of the second to the fourth embodiments include a plurality of equal source drivers, only one source driver will be described below.

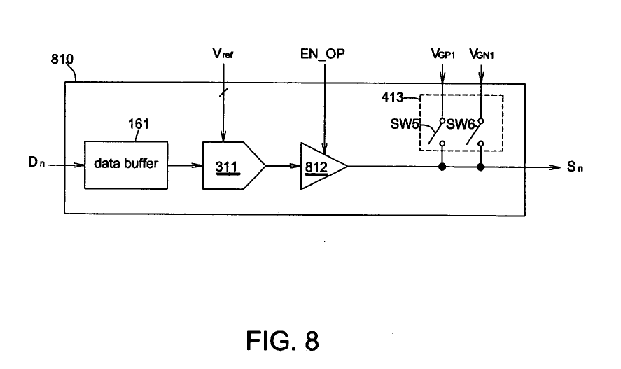

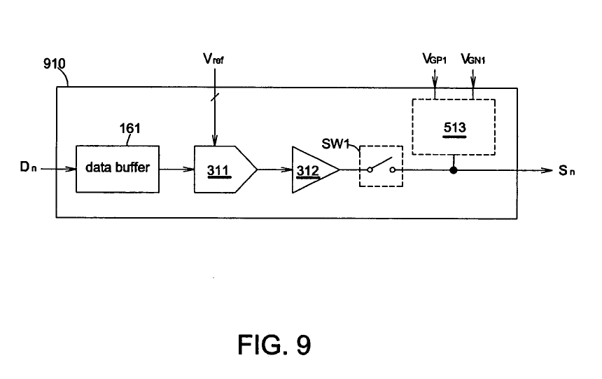

FIG. 8 shows a schematic configuration of a source driver circuit according to a third embodiment of the invention. FIG. 9 shows a schematic configuration of a source driver circuit according to a fourth embodiment of the invention.

Comparing FIG. 7, 8, the source drivers of the second and the third embodiments are quite similar, and the difference between them is that the third embodiment doesn't include the switch SW1. The operation of the amplifier 812 is controlled by an enable control signal EN_OP in the source driver 810 of the second embodiment. The amplifier 812 is enabled to output an amplified signal as the driving signal within the first trigger pulse period T1. During the second trigger pulse period T₂, the enable control signal EN_OP is disabled so that the output terminal of the amplifier 812 is in a high impedance state. Meanwhile, the black insertion unit 413 outputs a black insertion voltage as the driving signal.

Comparing FIG. 7 and FIG. 9, the source drivers of the second and the fourth embodiments are quite similar and the difference between them is the structure of the black insertion unit. The black insertion unit 413 is implemented using two switches SW5, SW6 in the second embodiment while the black insertion unit 513 is implemented using three switches SW5, SW6 and SW9 in the fourth embodiment.

The aim of the invention is to make it easier to implement the black insertion technique. With a simple hardware configuration, the invention efficiently achieves the aim of accelerating the data drive speed of source driver circuit and lowering the power consumption of the amplifiers.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A source driver circuit for a liquid crystal display device, the source driver circuit comprising a plurality of source driver, each source driver receiving two digital image signals and outputting a first driving signal and a second driving signal according to a plurality of gate driving signals, each gate driving signal having a first trigger pulse and a second trigger pulse within a frame period, each source driver comprising:
two data buffers for receiving the two digital image signals respectively;
two digital-to-analog converters for receiving the data output from the data buffers, and converting the data into two analog image signals according to two sets of reference analog voltage signals;
two amplifiers for outputting a first amplified signal and a second amplified signal after receiving and amplifying the two analog image signals;
a switch module for receiving the first and the second amplified signals and outputting the first and the second amplified signals as the first and the second driving signals within the first trigger pulse period;
a first black insertion unit for receiving a first black insertion voltage and a second black insertion voltage and outputting the first black insertion voltage or the second black insertion voltage as the first driving signal within the second trigger pulse period; and
a second black insertion unit for receiving the first black insertion voltage and the second black insertion voltage and outputting the first black insertion voltage or the second black insertion voltage as the second driving signal within the second trigger pulse period.

2. The source driver circuit as claimed in claim 1, wherein the first black insertion voltage, the second black insertion voltage and the two sets of reference analog voltage signals are provided by a gamma adjustment circuit.

3. The source driver circuit as claimed in claim 1, wherein the switch module comprises:
a first switch which receives the first amplified signal and is controlled by a first switch control signal;
a second switch which receives the second amplified signal and is controlled by a second switch control signal;
a third switch which receives the first amplified signal and is controlled by a third switch control signal; and
a fourth switch which receives the second amplified signal and is controlled by a fourth switch control signal;
wherein the output terminals of the first and the second switches are connected to each other where the first driving signal is output, and the output terminals of the third and the fourth switches are connected to each other where the second driving signal is output.

4. The source driver circuit as claimed in claim 3, wherein the first black insertion unit comprises:
a fifth switch which receives the first black insertion voltage and is controlled by a fifth switch control signal; and
a sixth switch which receives the second black insertion voltage and is controlled by a sixth switch control signal;
wherein the output terminals of the fifth and the sixth switches are connected to each other where the output terminals of the first and the second switches are connected, and both the fifth and the sixth switches are not turned ON simultaneously.

5. The source driver circuit as claimed in claim 3, wherein the first black insertion unit comprises:
a fifth switch which receives the first black insertion voltage and is controlled by a fifth switch control signal;
a sixth switch which receives the second black insertion voltage and is controlled by a sixth switch control signal; and
a ninth switch which is controlled by a ninth switch control signal, and the output terminal of which is connected to the output terminals of the first and the second switches;
wherein the output terminals of the fifth and the sixth switches are connected to each other where the input terminal of the ninth switch is connected, and both the fifth and the sixth switches are not turned ON simultaneously.

6. The source driver circuit as claimed in claim 4, wherein the second black insertion unit comprises:
a seventh switch which receives the first black insertion voltage and is controlled by a seventh switch control signal; and
an eighth switch which receives the second black insertion voltage and is controlled by an eighth switch control signal;
wherein the output terminals of the seventh and the eighth switches are connected to each other where the output terminals of the third and the fourth switches are connected, and both the seventh and the eighth switches are not turned ON simultaneously.

7. The source driver circuit as claimed in claim 4, wherein the second black insertion unit comprises:
a seventh switch which receives the first black insertion voltage and is controlled by a seventh switch control signal;
an eighth switch which receives the second black insertion voltage and is controlled by an eighth switch control signal; and
a tenth switch which is controlled by a tenth switch control signal, and the output terminal of which is connected to the output terminals of the first and the second switches;
wherein the output terminals of the seventh and the eighth switches are connected to each other where the input terminal of the tenth switch is connected, and both the seventh and the eighth switches are not turned ON simultaneously.

8. The source driver circuit as claimed in claim 2, wherein one of the first and the second black insertion voltages is positive, and the other is negative.

9. The source driver circuit as claimed in claim 2, wherein one of two sets of the reference analog voltage signals is a set of positive voltage signals, and the other is a set of negative voltage signals.

10. The source driver circuit as claimed in claim 1, wherein the first trigger pulse period is longer than the second trigger pulse period.

11. The source driver circuit as claimed in claim 1, wherein the first trigger pulse period is equal to the second trigger pulse period.

12. A source driving method for a liquid crystal display device, in which a plurality of scanning lines and a plurality of signal lines are disposed in a grid arrangement, each gate driving signal supplied to each scanning line having a first trigger pulse and a second trigger pulse within a frame period, the source driving method comprising the steps of:
amplifying and outputting a plurality of analog image signals to the plurality of signal lines after converting a plurality of digital image signals into the plurality of analog image signals within the first trigger pulse period; and
outputting two black insertion voltages to the plurality of signal lines within the second trigger pulse period;
wherein the two black insertion voltages are provided by a gamma adjustment circuit in the liquid crystal display device.

13. The source driving method as claimed in claim 12, wherein the time of activating the second trigger pulse for each scanning line is different.

14. The source driving method as claimed in claim 13, wherein the first trigger pulse period is longer than the second trigger pulse period.

15. The source driving method as claimed in claim 12, wherein the times of activating the second trigger pulses for every N scanning lines are the same.

16. The source driving method as claimed in claim 15, wherein N is equal to 4.

17. The source driving method as claimed in claim 12, wherein one of the first and the second black insertion voltages is positive, and the other is negative.

18. The source driving method as claimed in claim 17, wherein the step of outputting two black insertion voltages comprises the step of simultaneously outputting two black insertion voltages to the corresponding signal lines according to the predetermined polarity of each liquid crystal layer within the second trigger pulse period.

19. A source driver circuit for a liquid crystal display device, the source driver circuit comprising a plurality of source driver, each source driver receiving a digital image signal and outputting a driving signal according to a plurality of gate driving signals, each gate driving signal supplied to each scanning line having a first trigger pulse and a second trigger pulse within a frame period, each source driver comprising:
a data buffer for receiving the digital image signal;
a digital-to-analog converter for receiving the data output from the data buffer and converting the data into an analog image signal according to a set of reference analog voltage signal;
an amplifier for outputting an amplified signal after receiving and amplifying the analog image signal from the digital-to-analog converter;
a first switch for receiving the amplified signal and outputting the amplified signals as the driving signal within the first trigger pulse period; and
a black insertion unit for receiving a first black insertion voltage and a second black insertion voltage and outputting the first black insertion voltage or the second black insertion voltage as the driving signal within the second trigger pulse period.

20. The source driver circuit as claimed in claim 19, wherein the first black insertion voltage, the second black insertion voltage and the set of reference analog voltage signals are provided by a gamma adjustment circuit.

21. The source driver circuit as claimed in claim 19, wherein the first black insertion unit comprises:
a fifth switch which receives the first black insertion voltage and is controlled by a fifth switch control signal; and
a sixth switch which receives the second black insertion voltage and is controlled by a sixth switch control signal;
wherein the output terminals of the fifth and the sixth switches are connected to each other where the output terminal of the first switches is connected, and both the fifth and the sixth switches are not turned ON simultaneously.

22. The source driver circuit as claimed in claim 19, wherein the black insertion unit comprises:
a fifth switch which receives the first black insertion voltage and is controlled by a fifth switch control signal;
a sixth switch which receives the second black insertion voltage and is controlled by a sixth switch control signal; and
a ninth switch which is controlled by a ninth switch control signal, and the output terminal of which is connected to the output terminals of the first and the second switches;
wherein the output terminals of the fifth and the sixth switches are connected to each other where the input terminal of the ninth switch is connected, and both the fifth and the sixth switches are not turned ON simultaneously.

23. The source driver circuit as claimed in claim 19, wherein one of the first and the second black insertion voltages is positive, and the other is negative.

24. The source driver circuit as claimed in claim 19, wherein the first trigger pulse period is longer than the second trigger pulse period.

25. The source driver circuit as claimed in claim 19, wherein the first trigger pulse period is equal to the second trigger pulse period.

26. A source driver circuit for a liquid crystal display device, the source driver circuit comprising a plurality of source driver, each source driver receiving a digital image signal and outputting a driving signal according to a plurality of gate driving signals, each gate driving signal supplied to each scanning line having a first trigger pulse and a second trigger pulse within a frame period, each source driver comprising:
a data buffer for receiving the digital image signal;
a digital-to-analog converter for receiving the data output from the data buffer and converting the data into an analog image signal according to a set of reference analog voltage signal;
an amplifier which is controlled by an enable control signal and outputs an amplified signal as the driving signal within the first trigger pulse period after receiving and amplifying the analog image signal from the digital-to-analog converter; and
a black insertion unit for receiving a first black insertion voltage and a second black insertion voltage and outputting the first black insertion voltage or the second black insertion voltage as the driving signal within the second trigger pulse period;
wherein the amplifier outputs the driving signal while the enable control signal is enabled within the first trigger pulse period, and the output terminal of the amplifier is in a high impedance state while the enable control signal is disabled.

27. The source driver circuit as claimed in claim 26, wherein the first black insertion voltage, the second black insertion voltage and the set of reference analog voltage signals are provided by a gamma adjustment circuit.

28. The source driver circuit as claimed in claim 26, wherein the black insertion unit comprises:
a fifth switch which receives the first black insertion voltage and is controlled by a fifth switch control signal; and
a sixth switch which receives the second black insertion voltage and is controlled by a sixth switch control signal;
wherein the output terminals of the fifth and the sixth switches are connected to each other where the output terminal of the first switches is connected, and both the fifth and the sixth switches are not turned ON simultaneously.

29. The source driver circuit as claimed in claim 26, wherein the first black insertion unit comprises:
a fifth switch which receives the first black insertion voltage and is controlled by a fifth switch control signal;
a sixth switch which receives the second black insertion voltage and is controlled by a sixth switch control signal; and
a ninth switch which is controlled by a ninth switch control signal, and the output terminal of which is connected to the output terminals of the first and the second switches;
wherein the output terminals of the fifth and the sixth switches are connected to each other where the input terminal of the ninth switch is connected, and both the fifth and the sixth switches are not turned ON simultaneously.

30. The source driver circuit as claimed in claim 26, wherein one of the first and the second black insertion voltages is positive, and the other is negative.

31. The source driver circuit as claimed in claim 26, wherein the first trigger pulse period is longer than the second trigger pulse period.

32. The source driver circuit as claimed in claim 26, wherein the first trigger pulse period is equal to the second trigger pulse period.
